(19) United States
(12) Patent Application Publication
(10) Pub. No.: US 2004/0111698 A1
(43) Pub. Date: Jun. 10, 2004

(54) System and method for design, development, and deployment of distributed applications that share data from heterogeneous and autonomous sources over the Web

(75) Inventors: Edward L.W. Soong, Andover, MA (US); Dawei Zhang, Highlands, NJ (US); Shijia Zhu, Westford, MA (US)

Correspondence Address: ANEW TECHNOLOGY CORPORATION, 99 S. BEDFORD STREET, SUITE 203, BURLINGTON, MA, 01803, US

(73) Assignee: Anew Technology Corporation, Burlington, MA

(21) Appl. No.: 10/065,988

(22) Filed: Dec. 6, 2002

(51) Int. Cl. G06F 9/44

(52) U.S. Cl. 717/102; 717/104; 717/114

(57) ABSTRACT

This invention is related to a method for design and implementation of wide-area data sharing applications in the Internet and World Wide Web environment. The kernel of the invention is a middle tier that facilitates data integration over the Web. For each specific data sharing application, the middle tier is composed of an XML-based standard and an in-memory data structure. While the XML-based standard defines the syntax and semantics for the data to be shared and integrated, the in-memory data structure accommodates the data elements in a source-independent, relational format for manipulation in disconnected mode. The equivalency between the XML-based standard and the in-memory lays a solid basis for data integration over the Web. Data exchange in this distributed environment is realized by using Web services. Furthermore, the XML-based standard and in-memory data structure may also be extended to support distributed query processing and distributed transaction management in this environment.

### BACKGROUND OF INVENTION

With the advent of Internet and Web, Information Technology solutions for enterprise are moving toward a new era. Web Services makes distributed applications over the Web possible. In the data sharing and integration front, new standards are needed in order to provide consistent and scalable access to heterogeneous data sources with an entirely new programming model for data access. They should support disconnected data architecture, separation of data access and data manipulation, tight integration with XML, and the ability to combine data from multiple and varied sources. All these features lay the basis for a creative approach to data-sharing applications in the distributed environment of the Web and Internet. However, many issues need to be resolved in order to achieve the ultimate system and environment. The invention addresses the following issues:

1. Integrated access to heterogeneous data sources. The ability to access data that resides in multiple autonomous and heterogeneous data sources, in a uniform and integrated manner, is now becoming very important for software development. Apart from system-level incompatibilities between different database systems, incompatibilities also exist between the content of different but semantically related databases. The heterogeneity and autonomy characteristics of the local database systems have to be resolved in order to carry global operations like queries and transactions. In addition, heterogeneity among the contents of the local databases has to be shielded from the global users who want to view the collection of databases as an integrated entity. In order to meet this goal, data access has to be separated from data manipulation. The data access modules retrieve data from various sources, from traditional databases to semi-structured Web repositories. They convert the data from different sources into a consistent form, which is handled by the data manipulation modules. Then the manipulation results are used to update the data in the sources. In other words, data access modules conceal the discrepancy of the source data and allows for a coherent treatment of data integration.

2. Working with disconnected set of data. In traditional client/server environment, an application establishes a connection to a database and keeps it open while the application is running. This approach, however, is impractical for Web-based applications. Open database connections take up considerable amount of system resources. In most cases, databases can maintain only a small number of concurrent connections. Moreover, the overhead of maintaining these connections degrades overall performance and makes the application difficult to scale up. Therefore, it is desired that open connections be retained only long enough to perform database operations, such as read data from the database or write it back. The data access module opens a connection, retrieves the data to the uniform data structure in the memory, and then closes the connection. While the data is processed in memory, no connection is maintained for this piece of data. When the processing job is done, the data access module opens a connection again for database update. As one piece of data is manipulated, a connection may be opened to handle another piece of data. Furthermore, a pool of connections may be maintained to reduce the overhead for creating and destroying the connection objects.

3. Tight integration with XML. Currently, there is an increasing interest in building information integration applications with an XML-based middleware. XML is a W3C standard designed to facilitate data exchange between Web-based applications. It allows a natural representation of data coming from any kinds of source, ranging from well-structured database to semi-structured document management systems. In addition, XML facilitates interoperability between the various components of an integrated system. However, use of XML as a middleware integration technology still raises a number of pending issues, among which a serious problem is lacking of effective and efficient ways for conversion between XML streams and data in various existing sources. For example, DOM (Document Object Model) requires that an entire XML document be represented as a tree in the memory. This can be a heavy weight operation even for medium-sized files in terms of memory utilization. To make it worse, paging and swapping would cause serious performance degradation when the tree becomes larger than the size of available physical memory. On the other hand, SAX (Simple API for XML) substitutes an event-driven and procedural model for the object-oriented framework of DOM. SAX is able to process XML documents as streams, acting upon each element and content as it is encountered. But it cannot catch the data structures represented by XML documents; SAX itself is blind to the most of what is interesting about XML. Therefore, it is very much desirable that, in our solution for data access, the XML streams also be treated in a uniformed fashion. Conversion between data in XML format and our internal structure for data manipulation should be fully automated, requiring minimum programming effort. Furthermore, this conversion must be based on a formal specification for the syntax of the XML data, namely XML Schema.

4. Data exchange via the Web and Internet. The Internet, together with World Wide Web, has provided an opportunity to unite geographically dispersed users and computing resources into an integrated computing environment. The key to providing such an environment is to develop such a mechanism that allows users to transparently share data from the various sources over the Web. In addition to support integration of heterogeneous data, we need further to supply a built-in mechanism for data exchange via the Web and Internet. With such a mechanism, channels ought to be easily established, through which data is transferred in a standard format between its suppliers and consumers. Ideally, a proxy should be automatically created that provides a local access to the remote data object so that the programmers may concentrate on the business logic without having to worry about the communication details.

5. Distributed Query Processing. In a Web-based data-sharing application, a distributed query is first translated into an efficient execution plan expressed on local databases. Such translation has two important aspects. First, the translation must be a correct transformation of the input query so that the execution plan actually produces the expected result. Second, the execution plan must be “optimal,” i.e. it must minimize a cost function that captures resource of its consumption. This requires investigating equivalent alternative plans in order to select the best one. Because of the difficulty of addressing these two aspects together, they are typically isolated in two sequential steps known as data localization and global optimization, respectively. Not only usage of computational resource of local sub-systems but also communication costs and load balancing have to be taken into account. The heterogeneity and autonomy of the local sub-system further complicated the query processing in the distributed environment.

6. Distributed Transaction Management. In a distributed database that is composed of homogeneous local databases, 2-phase locking protocol and 2-phase commit protocol are used to manage distributed transactions. In the distributed applications with heterogeneous and autonomous local sub-systems, however, the 2-phase protocols may not be acceptable because either the local sub-systems do not support these protocols or these protocols would violate the autonomy of the local sub-systems. In order to manage distributed transactions in such an environment, a global transaction manager needs to be built on top of the local transaction management mechanism of the participating sub-systems whereby the global transaction that span multiple local transactions can be executed without resulting in violations of the local data consistency.

### SUMMARY OF INVENTION

In this context, our invention includes:

1. Solution. In our solution, Web-based data-sharing application starts with an XML-based standard for data exchange. Such a standard serves a domain-based global schema. The owners of all the participating sub-systems should be involved with this standardization process. Therefore, the XML-based standard that is worked out reflects an agreement for the data-exchange between the participating sub-systems. In reality, however, many standards of this kind have been established for various vertical industries. Then, the infrastructure for the data sharing can be automatically built up according to the XML-based standard. In this process, an object of in-memory, relational data structure is created in each participating sub-systems that is consistent with the XML-based standard. This construct allows the participating sub-systems to share data in the way that they have agreed upon. Finally, Web-based remote method invocation facilitates a request/response mechanism whereby the data is transferred between the participating sub-systems. In this communication, XML messages carry the data that confined with the original standard. In this sense, our XML-based standard also serves as the transfer syntax. In addition, the objects for data sharing are working with disconnected set of data. Database connection is opened only when an object needs to be synchronized with its data source. As soon as the database operation is completed, the database connection can be closed again. Therefore, distributed applications that share data from heterogeneous and autonomous sources over the Web can be realized with modest computational resources.

2. Programming Model. With our programming model, Web-based data-sharing applications are designed and implemented in an object-oriented fashion. An extendable class library is also supplied that simplifies the development tasks. Because distributed processing on the Web is a very active area in research and development, our programming model supports a flexible framework for adopting new innovations in this field.

3. Tool Kit. A GUI-based tool kit that supports installation, customization, and administration of the Web-based data-sharing application systems. It will also be used to set-up problem-oriented distributed queries and distributed transactions.

4. Server Product . A light-weighted data-consolidation server is a part of our solution. It accommodates the infrastructure for Web-based data sharing and only connects to the database in a participating sub-system when synchronization is needed.

### BRIEF DESCRIPTION OF DRAWINGS

FIG. 1 is a block diagram showing middle tier for integrated access to heterogeneous data.

FIG. 2 is a block diagram illustrating the in-memory data structures that are created based on the XML Schema Definition (XSD) of the data-exchange standard.

FIG. 3 is a block diagram illustrating XML Web services for data sharing over the Web.

FIG. 4 is a block diagram detailing how to display data from different sources on a Web page.

### DETAILED DESCRIPTION

The present invention is embodied in an XML-based middle tier whereby data-sharing applications in the distributed environment of the Internet and Web may be easily developed.

As a part of this invention, interfaces are implemented that synchronizes the content of in-memory data structure and various data sources.

An XML standard is designed as the global schema for data sharing in distributed environment, based on which the corresponding in-memory data structures are created for local data processing in the participating sub-systems. Furthermore, the XML standard also serves as the transfer syntax when the content of the in-memory data are exchanged between the participating sub-systems. The equivalency between the XML-based standard for data sharing and the in-memory data structure for data manipulation is the foundation of the invention.

The XML-based middle tier in our invention for data sharing in distributed environment provides global applications with a consistent view of data in various sources.

Logically, the middle tier is composed of an in-memory data structure and an interface to the data source. While the in-memory data architecture has no knowledge of the data source behind it, it is the interface to the database that populates the in-memory data structure and resolves updates with the data source.

Physically, the middle tier may be implemented in the following ways.

The middle tier is implemented within the sub-system.

The middle tier is implemented as a front-end on a separate hardware platform.

If Microsoft ADO.NET technology is used, the middle tier may be implemented with sub-systems that support Microsoft NET Framework. For sub-system that does not support Microsoft .NET Framework, a separated front-end is implemented through which the sub-system can join the distributed data sharing environment. Our solution and programming model may be implemented under different platforms. For example, it can also be implemented with J2EE standards.

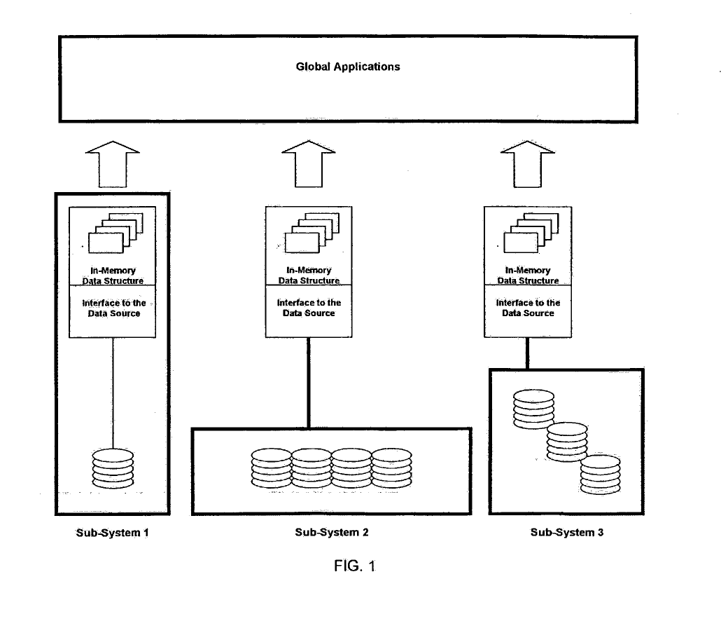

This construct is depicted in FIG. 1. In this figure, the middle tier for sub-system 1 is implemented within the sub-system, while those for sub-system 2 and 3 are implemented in separate hardware platform.

Traditional client/server application maintains a connection to a database during its lifetime. This approach would cause serious performance and scalability in Web-based applications. The XML-based middle tier in our invention works with disconnected set of data in the in-memory data structure. Distributed data sharing over the Web can be realized with modest computational resources.

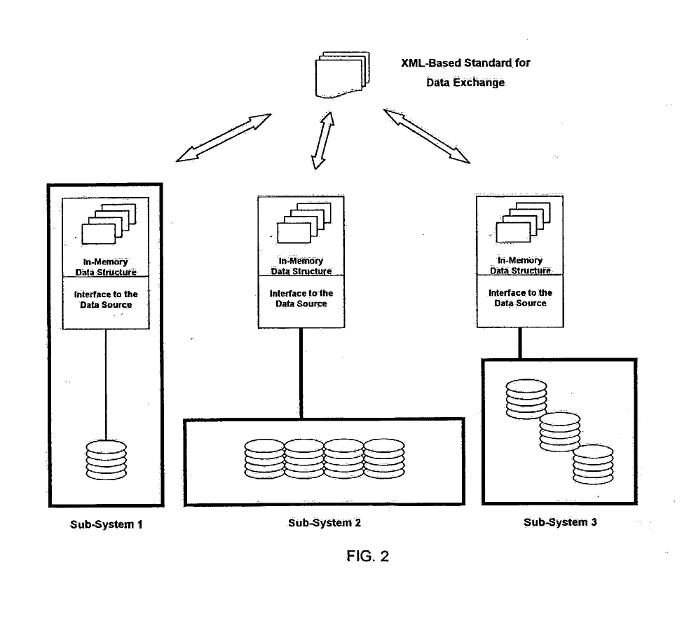

Due to the equivalency, data in format of the XML-based standard for data sharing and that the in-memory data structure for data manipulation can be converted back and forth automatically in our invention. Therefore, the middle tier may be design and implemented in the following ways for a specific distributed application as shown in FIG. 2.

The XML-based standard for data sharing in the form of XSD, XML Schema is first defined, and the in-memory data structure can then be create by inferring the data relations embedded in the XSD. This method is very much useful as many XML-based standards for data sharing have been set up for various industries.

The relational construction of the in-memory data structure is first defined and the XML-based standard for data sharing may be derived from the definition of the in-memory data structure. In addition, data in the in-memory data structures can thus be exchanged over the Internet in the format of the XML-based standard.

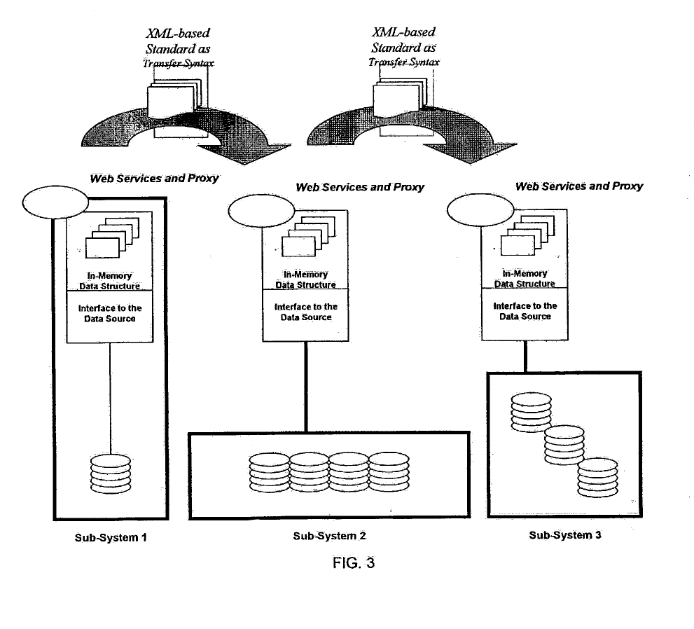

When the middle tiers are built, data sharing can be realized among the participating sub-systems via the standard web services. On the server site, web service may be implemented that either returns a local object of in-memory data structure, or takes a remote object of in-memory data structure as an argument. An application at the client site may invoke the local proxy to access the web service and, as a result, the object of in-memory data structure is serialized into XML message that follows the pre-defined standard, which is then transferred over the Internet (see. FIG. 3).

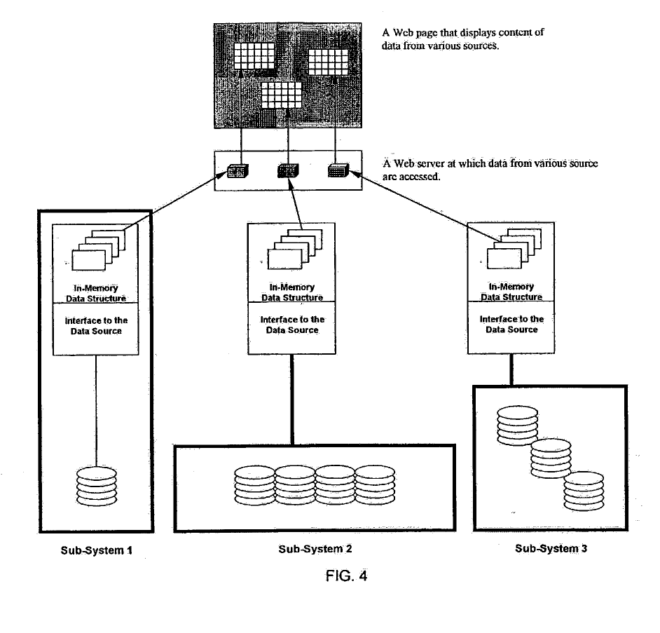

A simple example of global application under this environment is shown in FIG. 4. The web server in this figure accesses the in-memory structures in the 3 sub-systems and then publishes the data elements to the Web so that they may be displayed on a Web page.

The same paradigm is used for query processing and transaction management for the Web-based distributed applications. The XML-based standard, as well as the corresponding in-memory data structure, are extended to accommodate the request and response of the task.

When a distributed query is submitted to the system, it is decomposed into a set of local query requests for the related sub-systems. In each sub-system, web services are implemented that handle these local query requests. The web services take the local query request as its argument and returns the local query result as a response to its remote caller. The XML-standard for data sharing, as well as its corresponding in-memory data structure, is extended to accommodate both requests and responses for distributed queries. They are manipulated in sub-systems, and exchanged among the sub-systems, in the exactly the same way as the objects of in-memory data structure and XML messages following the pre-defined data sharing standard.

Similarly, a distributed transaction is decomposed to a set of local transaction requests when it is submitted to the system. Extended XML-standard and the corresponding in-memory data structure are also used to carry information for coordinate the local transactions, as well as the data to be shared among them. This scheme may support various kind transactions, including short-time transactions for business applications with constraints of atomicity, consistency, isolation, and durability, such as fund transfer, and long-time transaction with semantic-based integrity rule and data sharing for cooperative applications, such as CAD/CAM and joint software development.

1. An information processing system and method for planning, design, and implementation of Web-based data integration, distributed query processing, and distributed transactions management, comprising:
(a)A software solution that includes an XML-based middleware for developing Web-based distributed applications.
(b)A programming model that defines the underlining architecture.
(c)A Graphical User Interface (GUI)-based tool kit that supports installation, customization, and administration of the Web-based applications under this architecture.

2. The information processing system and method of claim 1 wherein said software solution consists of an XML-based standard for data sharing and the corresponding in-memory data structure.

3. The software solution of claim 2 wherein said XML-based standard serves as the global schema for the distributed environment and the transfer syntax for data exchange among the participating sub-systems in this environment.

4. The software solution of claim 2 wherein said XML-based standard defines the transfer syntax for marshaling the objects of in-memory data structure over the Internet.

5. The software solution of claim 2 wherein said in-memory data structure is a relational data representation for local manipulation in disconnected mode. Under this construct, the participating sub-system may share data in the way that they have agreed upon.

6. The software solution of claim 2 wherein said in-memory data structure is a class and objects as its instance may be taken by web services as arguments and may be returned by web services.

7. The software solution of claim 2 wherein said XML-base standard and corresponding in-memory data structure are equivalent. That is, the data elements in the XML message that follows the standard, and those reside in the in-memory data structure may be seamlessly converted back and forth. This equivalency has laid the basis for the method of our invention.

8. The method of claim 1 wherein said software solution provides a systematical way in which distributed query processing and distributed transaction management may be carried out.

9. The method of claim 1 wherein said middleware is composed of the in-memory data structure and an interface to the data sources. It is the interface that synchronizes the data structure and its data sources, so that the discrepancy between heterogeneous data sources can be cancelled.

10. The method of claim 1 is implemented in data-consolidation server products by using various technology, including Microsoft .NET Framework and J2EE standard.
